(19) United States
(12) Patent Application Publication
(10) Pub. No.: US 2014/0345197 A1
(43) Pub. Date: Nov. 27, 2014

(54) INSTANT TOMATO GROWING KIT

(71) Applicant: X-SEED, INC., Clear Lake, MN (US)

(72) Inventor: Charles R. Fagin, Clear Lake, MN (US)

(73) Assignee: X-SEED, INC., Clear Lake, MN (US)

(21) Appl. No.: 14/184,135

(22) Filed: Feb. 19, 2014

Related U.S. Application Data
(60) Provisional application No. 61/827,218, filed on May 24, 2013.

(51) Int. Cl. A01G 9/02; A01G 1/00

(52) U.S. Cl. CPC A01G 9/02; A01G 1/001
USPC 47/66.7; 47/65.5

(57) ABSTRACT

A kit for cultivating a plant having at least one seed of said plant, an amount of a compressed growing medium for germination and growth of said seed or seeds upon the absorption of water into said compressed medium, said growing medium comprising at least one growing composition; a collapsible container for containing said growing medium and said at least one seed, in which said plaint is to be initially cultivated, said collapsible container being sized so as to snugly accommodate the compressed growing medium when said growing medium has been expanded by the addition of water, wherein during said initial cultivation of said peat, and seed are arranged in said container; and a tray for supporting said collapsible container, wherein the tray includes at least one hole for allowing water to escape from the tray.

### CLAIM OF PRIORITY

This application claims priority to U.S. Provisional Patent Application No. 61/827,218 filed May 24, 2014, the entire application of which, is incorporated by reference.

### FIELD OF THE INVENTION

This invention relates to a kit for cultivating a plant, more particularly to a kit including substantially all the necessary principal components for planting, germinating and growing a plant, for example a tomato.

### BACKGROUND OF THE INVENTION

Growing tomatoes has traditionally been limited to in-ground planting or planting in large pots for deck and balcony cultivation. Growing tomatoes on a deck, patio or from a basket requires a special formulation of soil, frequent watering, and proper drainage. Existing grow kits do not provide growing mediums or offer planters that can hold in heat while still draining excess water. Furthermore, it is difficult for the end user to formulate the proper additives and nutrients to achieve the ideal pH levels and allow for maximum magnesium and calcium plant uptake.

### SUMMARY OF THE INVENTION

One aspect the present invention provides a kit for cultivating a tomato. The kit includes an amount of a compressed growing medium for germination and growth of said seed or seeds upon the absorption of water into said compressed medium, said growing medium comprising at least one growing composition; a collapsible container for containing said growing medium and said at least one seed, in which said plaint is to be initially cultivated, said collapsible container being sized so as to snugly accommodate the compressed growing medium when said growing medium has been expanded by the addition of water, wherein during said initial cultivation of said peat, and seed are arranged in said container; and a tray for supporting said collapsible container, wherein the tray includes at least one hole for allowing water to escape from the tray.

In another embodiment, the invention includes a method of cultivating a tomato from a kit comprising in combination at least one seed of said plant, an amount of a compressed growing medium, for germination and growth of said seed of seeds upon the absorption of water into said compressed growing medium, said growing medium comprising at least one growing composition, and a water resistant container for containing said growing medium, and at least one seed, in which said plant is to be initially cultivated, said container being sized so as to snugly accommodate the volume said expanded growing medium wherein, said growing medium and said seed or seeds are each provided in respective packages within said container. The inventive method comprises the steps of:

(i) removing said respective packages from said container;

(ii) adding water to the growing medium to expand said medium to its expanded size and placing said expanded growing medium snugly into said container;

(iii) planting said seed or seeds in said growing composition by pushing said seed or seeds into an upper surface of said growing medium; and

(iv) allowing said seed or seeds to germinate and grow under suitable growing conditions.

The present invention includes a pop-up container that holds heat using a dark, preferably black, lined 400 denier fabric with drainage holes on the bottom. This container may comprise a bag that allows for air to enter that could initiate self tapping in some plants, causing an increased root ball size. The present invention allows for proper water run off, while also functioning as a storage device for minimizing required storage space when not in use. In one embodiment, the invention includes a soil-less growth medium comprised of coir pith, fertilizer, gypsum, and other active ingredients such as live microbes.

The present invention allows the end user to simply expand the spring bag, add the growth medium and water and then plant a tomato, vegetable, or herb. The present invention also allows for added moisture retention, proper drainage, adequate nutrients for up to three months, and proper pH level for growing vegetables such as tomatoes.

### BRIEF DESCRIPTION OF THE DRAWINGS

FIG. 1 is a perspective view of a kit in accordance with the invention;

FIG. 2 is a perspective view of a tray in accordance with the invention;

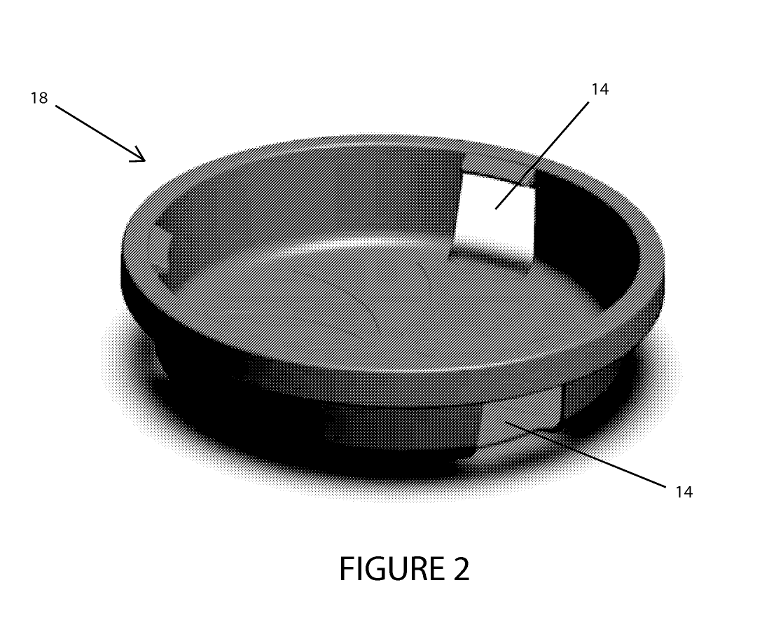

FIG. 3 is a perspective view of a collapsed kit in accordance with the invention;

FIG. 4 is a perspective view of a kit containing a growing medium in accordance with the invention.

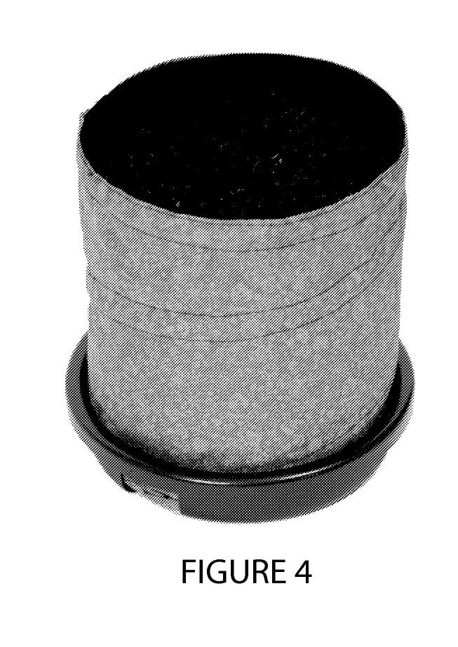

### DETAILED DESCRIPTION OF THE DRAWINGS

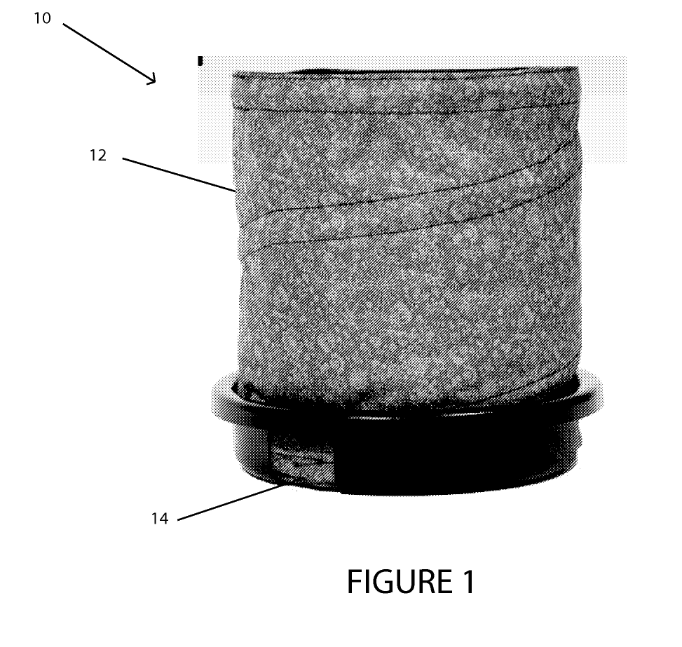

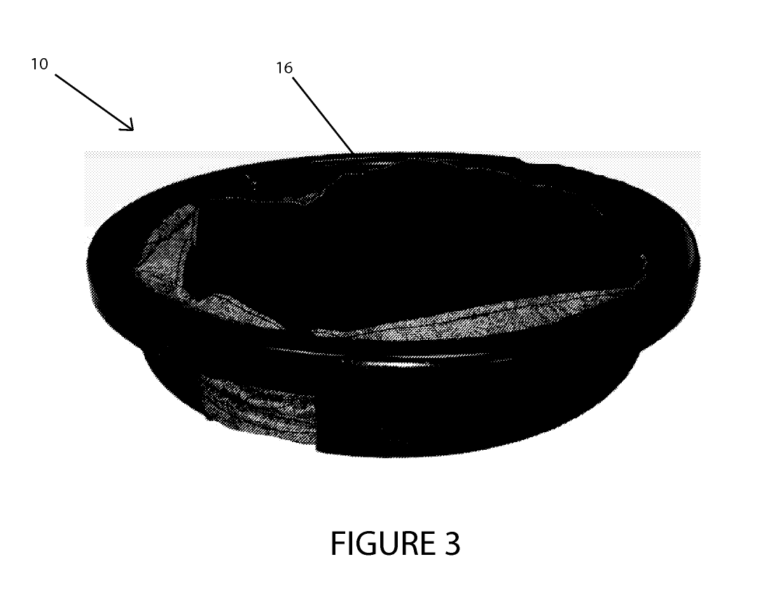

With reference to FIG. 1, the present invention includes a pop-up planter 10 that holds heat using a dark, lined 400 denier fabric 12 with drainage holes 14 on the bottom. This container may comprise a bag 16 that allows for air to enter that could initiate self tapping in some plants, causing an increased root ball size. The present invention allows for proper water run off, while also functioning as a storage device for minimizing required storage space when not in use, as shown in FIG. 3. In one embodiment, the invention includes a soil-less growth medium 20 comprised of coir pith, fertilizer, gypsum, and other active ingredients such as live microbes.

The present invention allows the end user to simply expand the spring bag from the position shown in FIG. 3 to the position shown in FIG. 1, add the growth medium and water and then plant a tomato, vegetable, or herb. The present invention also allows for added moisture retention, proper drainage, adequate nutrients for up to three months, and proper pH level for growing vegetables such as tomatoes.

The invention comprises a pre-formulated soil with pH for growing vegetables such as tomatoes. It allows for proper water drainage, larger plant root development, enhanced water absorption and retention and reduced space requirements for off-season storage.

With respect to the pre-formulated soil in the growing medium 20, the present invention will now be discussed. The present invention is formulated to achieve the ideal pH levels and allow for maximum magnesium and calcium plant uptake for a soilless growth medium. This is achieved with a combination of coir pith, fertilizer and organic material, gypsum, and active microbes.

Ordinary soils and planters can become compact and do not allow for proper drainage and water retention. The present invention contains a natural super absorbent growth medium with better water retention and drainage. The naturally-aerated structure of this medium lets it hold up to 4 times its weight in water. The planter 10 of the present invention is designed to funnel water from the holes in the bag, through the compartment on the tray 18, and out the sides.

The growing medium of the present invention utilizes 90-98% coir pith-low compaction; tough coarse fibers to resist crushing. Containers filed with coir do not “settle as is the case with peat moss and other soilless mediums. More air space means more oxygen can reach roots. The planter of the present invention is comprised of 400 denier fabric, which allows for water to drain and air to be absorbed. More air means more oxygen can reach the roots.

The growing medium 20 of the present invention, which utilizes 90-98% coir pith is naturally super absorbent with excellent water retention and drainage properties. The naturally-aerated structure of this medium enables it to hold up to 4 times its weight in water. However, because the material is fibrous, moisture drains well to the bottom of the container. The growing medium 20 also provides low compaction properties because it has tough, coarse fibers that resist crushing. This configuration requires less maintenance than usual potting mixes because it retains moisture and nutrients. Coir is 100% natural and biodegradable and is a renewable resource because coir is made from coconut-processing waste. The present invention results in less humidity due to good drainage, thereby reducing disease strikes.

The kit of the present invention can fold down and lock under special tabs and hold the spring bag in place, as shown in FIG. 3. This allows for multiple trays and bags to be stacked, thereby minimizing storage space.

1. A kit for cultivating a plant, the kit comprising in combination:
at least one seed of said plant;
an amount of a compressed growing medium for germination and growth of said seed or seeds upon the absorption of water into said compressed medium, said growing medium comprising at least one growing composition;
a collapsible container for containing said growing medium and said at least one seed, in which said plaint is to be initially cultivated, said collapsible container being sized so as to snugly accommodate the compressed growing medium when said growing medium has been expanded by the addition of water, wherein during said initial cultivation of said peat, and seed are arranged in said container;
a tray for supporting said collapsible container, wherein the tray includes at least one hole for allowing water to escape from the tray.

2. A kit according to claim 1, wherein said growing medium comprises peat as a first growing composition.

3. A kit according to claim 2, wherein said peat is in the form of a water-expandable pellet.

4. A kit according to claim 2, wherein said growing medium further comprises gravel as a second growing composition.

5. A kit according to claim 1, wherein said container is a spring bag lined with 400 denier fabric with drainage holes on the bottom.

6. A kit according to claim 1, wherein said plant is selected from the group consisting of tomatoes and herbs.

7. A method of cultivating a tomato from a kit comprising in combination at least one seed of said plant, an amount of a compressed growing medium, for germination and growth of said seed of seeds upon the absorption of water into said compressed growing medium, said growing medium comprising at least one growing composition, and a water resistant container for containing said growing medium, and at least one seed, in which said plant is to be initially cultivated, said container being sized so as to snugly accommodate the volume said expanded growing medium wherein, said growing medium and said seed or seeds are each provided in respective packages within said container, said method comprising the steps of:
(i) removing said respective packages from said container;
(ii) adding water to the growing medium to expand said medium to its expanded size and placing said expanded growing medium snugly into said container;
(iii) planting said seed or seeds in said growing composition by pushing said seed or seeds into an upper surface of said growing medium; and
(iv) allowing said seed or seeds to germinate and grow under suitable growing conditions.

8. A method according to claim 7, wherein a second growing composition is placed in said container after step [iii].

9. A method according to claim 8, wherein said second growing composition is gravel.

10. A method according to claim 7, wherein the growing composition of step [ii] is peat.

11. A method according to claim 10, wherein said peat is in the form of a water-expandable pellet which is treated with water and thereby expanded prior to placing in the container.

12. A method according to claim 7, wherein said container is a spring bag incorporating a lined 400 denier fabric with drainage holes on the bottom.

13. A method according to claim 7, wherein said plant is selected from the group consisting of tomatoes and herbs.

14. A kit for cultivating a plant, the kit comprising in combination:
at least one seed of said plant;
an amount of gravel;
an amount of a compressed coir growing medium for germination and growth of said seed or seeds upon the absorption of water into said compressed coir, said growing medium comprising at least one growing composition;
a water resistant container for containing said growing medium, said seed, and
said amount of gravel, in which said plant is to be initially cultivated, said container being sized so as to snugly accommodate the compressed peat growing medium when said growing medium has been expanded by the addition of water, wherein during said initial cultivation said peat, gravel and seed are arranged in said container.
